(19) United States
(12) Patent Application Publication
(10) Pub. No.: US 2006/0109773 A1
(43) Pub. Date: May 25, 2006

(54) Objective optical system for optical recording media and optical pickup device using it

(75) Inventors: Toshiaki Katsuma, Tokyo (JP); Yu Kitahara, Saitama City (JP); Masao Mori, Saitama City (JP); Tetsuya Ori, Koshigaya City (JP)

Correspondence Address: ARNOLD INTERNATIONAL, P. O. BOX 129, GREAT FALLS, VA, 22066-0129, US

(73) Assignee: FUJINON CORPORATION

(21) Appl. No.: 11/280,321

(22) Filed: Nov. 17, 2005

(30) Foreign Application Priority Data
Nov. 22, 2004 (JP) 2004-337638

(51) Int. Cl. G11B 7/00

(52) U.S. Cl. 369/112.23

(57) ABSTRACT

An objective optical system for focusing light from a light source onto optical recording media includes an objective lens formed of, arranged in order from the light source side along an optical axis, a plastic lens element having a diffractive surface on its light source side and a glass lens element having positive refractive power and an aspheric surface. The lens elements are joined to form a lens component. The objective optical system focuses incident light of three different wavelengths with two or three different numerical apertures onto three different optical recording media. Three conditions are satisfied so as to achieve optimum focusing onto three different recording media, such as a CD, a DVD, and a BD or an AOD.

### FIELD OF THE INVENTION

The present invention relates to an objective optical system for optical recording media wherein light to be used can efficiently converge onto a corresponding optical recording medium when recording or reproducing information on one of three different optical recording media with different technical standards, such as, three different wavelengths of light, three different numerical apertures corresponding to the three different wavelengths of light, and three different substrate thicknesses of the three different optical recording media. More specifically, the present invention relates to an objective optical system for optical recording media wherein light of the three different wavelengths to be used can excellently focus onto the three different recording media by using the diffractive effects of a diffractive surface and the refractive effects of a lens surface. The present invention further relates to an optical pickup device that uses this objective optical system.

### BACKGROUND OF THE INVENTION

In response to the development of various optical recording media in recent years, optical pickup devices that can record information on and reproduce information from various types of optical recording media have been known. For example, as an objective lens for an optical pickup device, Japanese Laid-Open Patent Application H10-268117 discloses an objective lens formed of a lens element arranged on the optical recording medium side and integrally attached on its light source side surface to another lens element that includes a Fresnel structured surface.

Furthermore, devices that carry out recording and reproducing information with either a DVD (Digital Versatile Disk) or a CD (Compact Disk including CD-ROM, CD-R, CD-RW) have been practically used.

For these two types of optical recording media, the DVD uses visible light having a wavelength of approximately 650 nm for improved recording densities, while the CD is required to use near-infrared light having a wavelength of approximately 780 nm because some CDs have no sensitivity to visible light. Therefore, a single optical pickup device, known as a double wavelength pickup device, uses incident light of these two different wavelengths. Furthermore, the two optical recording media described above require different numerical apertures (NA) due to their different features. For example, the DVD is standardized to use light having a numerical aperture of about 0.6 through 0.65, and the CD is standardized to use light having a numerical aperture of about 0.45 through 0.52. Additionally, in these optical recording media, the substrate thicknesses, i.e., the geometrical thicknesses of the protective layers or substrates made of polycarbonate (PC), are standardized to different thicknesses. For example, the DVD may have a standard substrate thickness of 0.6 mm and the CD may have a standard substrate thickness of 1.2 mm.

Additionally, in response to rapid increases in the amount of data required to be recorded, the demand for an increase in the recording capacity of optical recording media has been stronger. It is known that the recording capacity of an optical recording medium can be increased by using light of a shorter wavelength and by increasing the numerical aperture (NA) of an objective optical system. Concerning a shorter wavelength, the development of a semiconductor laser with a shorter wavelength using a GaN substrate (for example, a semiconductor laser that emits a laser beam of 405 nm wavelength) has advanced to the point where this wavelength is becoming practical. With the development of short wavelength semiconductor lasers, research and development of AODs (Advanced Optical Disks), also known as HD-DVDs, that provide an increased data storage capacity of approximately 20 GB with a single layer on one side of an optical disk by using light of a shorter wavelength, has similarly progressed. As the AOD technical standard, the numerical aperture and disk thickness have been selected to be about the same as those of DVDs, as discussed previously, with the numerical aperture (NA) and disk substrate thickness for an AOD being set at 0.65 and 0.6 mm, respectively.

Furthermore, research and development of Blu-ray disk (BD) systems that use a shorter wavelength of disk illuminating light, similar to AOD systems, have also progressed. Moreover, the technically standardized values of numerical aperture and disk thickness for these systems are completely different from the corresponding DVD and CD values, with a numerical aperture (NA) of 0.85 and a disk substrate thickness of 0.1 mm being standard. Unless otherwise indicated, hereinafter AODs and Blu-ray disks (BDs) collectively will be referred to as “AODs.”

Currently, there is a demand for the development of an optical pickup device that can be commonly used for the three different types of optical recording media, AODs, DVDs and CDs. As described above, in these optical recording media, the wavelengths of light to be used and the substrate thicknesses are standardized to be different according to the type of optical recording media, resulting in the amount of spherical aberration generated by the thicknesses of the protective layers being different because the thicknesses are different. Consequently, for optimum focusing of each of the light beams on the corresponding optical recording medium, it is necessary to optimize the amount of spherical aberration in each light beam of each wavelength for recording and reproducing. This makes it necessary to design devices with a lens configuration having different focusing effects on the recording media according to the light beam and recording medium being used.

### BRIEF SUMMARY OF THE INVENTION

The present invention relates to an objective optical system for optical recording media that is of simple construction. In the present invention, an inexpensive and compact optical system is obtained using a diffractive surface that enables efficient focusing of light onto each of three different optical recording media using light beams of three different wavelengths for recording and reproducing information. The objective optical system for optical recording media of the present invention enables efficient focusing of the three light beams at a respective desirable position on a corresponding one of three optical recording media, according to technical standards of the wavelengths of the three light beams, the numerical apertures of the objective optical system at the three wavelengths, and the substrate thicknesses of the substrates of the three optical recording media. The present invention further relates to an optical pickup device that uses such an objective optical system.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A-1C are schematic diagrams that depict cross-sectional views of the objective optical system for optical recording media according to Embodiment 1 of the present invention, with FIG. 1A showing the operation of the objective optical system when used with a first optical recording medium 9a, with FIG. 1B showing the operation of the objective optical system when used with a second optical recording medium 9b, and with FIG. 1C showing the operation of the objective optical system when used with a third optical recording medium 9c;

FIGS. 2A-2C are schematic diagrams that depict cross-sectional views of the objective optical system for optical recording media of Embodiment 2 of the present invention, with FIG. 2A showing the operation of the objective optical system when used with the first optical recording medium 9d, with FIG. 2B showing the operation of the objective optical system when used with the second optical recording medium 9b, and with FIG. 2C showing the operation of the objective optical system when used with the third optical recording medium 9c;

FIGS. 3A-3C are schematic diagrams that depict cross-sectional views of the objective optical system for optical recording media of Embodiment 3 of the present invention, with FIG. 3A showing the operation of the objective optical system when used with the first optical recording medium 9a, with FIG. 3B showing the operation of the objective optical system when used with the second optical recording medium 9b, and with FIG. 3C showing the operation of the objective optical system when used with the third optical recording medium 9c;

FIGS. 4A-4C are schematic diagrams that depict cross-sectional views of the objective optical system for optical recording media of Embodiment 4 of the present invention, with FIG. 4A showing the operation of the objective optical system when used with the first optical recording medium 9d, with FIG. 4B showing the operation of the objective optical system when used with the second optical recording medium 9b, and with FIG. 4C showing the operation of the objective optical system when used with the third optical recording medium 9c; and

FIG. 5 is a schematic diagram of an optical pickup device that uses the objective optical system for optical recording media according to the embodiments of the invention.

### DETAILED DESCRIPTION

The present invention relates to an objective optical system for optical recording media that may be used to focus three light beams of wavelength λ1, λ2, and λ3, respectively, from a light source to a different desired position for each of a first, second and third optical recording medium having a substrate thickness of T1, T2, and T3, respectively, for recording and reproducing information. As herein defined, unless otherwise indicated, the term “light source” refers to the source of the three light beams, whether the light beams originate from a single light-emitting source or from separate light-emitting sources such as semiconductor lasers. Additionally, the term “light source” may also include various optical elements, including beam splitters, mirrors, and converging lenses, which for one or more of the light beams of wavelengths λ1, λ2, and λ3 may operate as a collimator lens to provide a collimated light beam incident on the objective optical system.

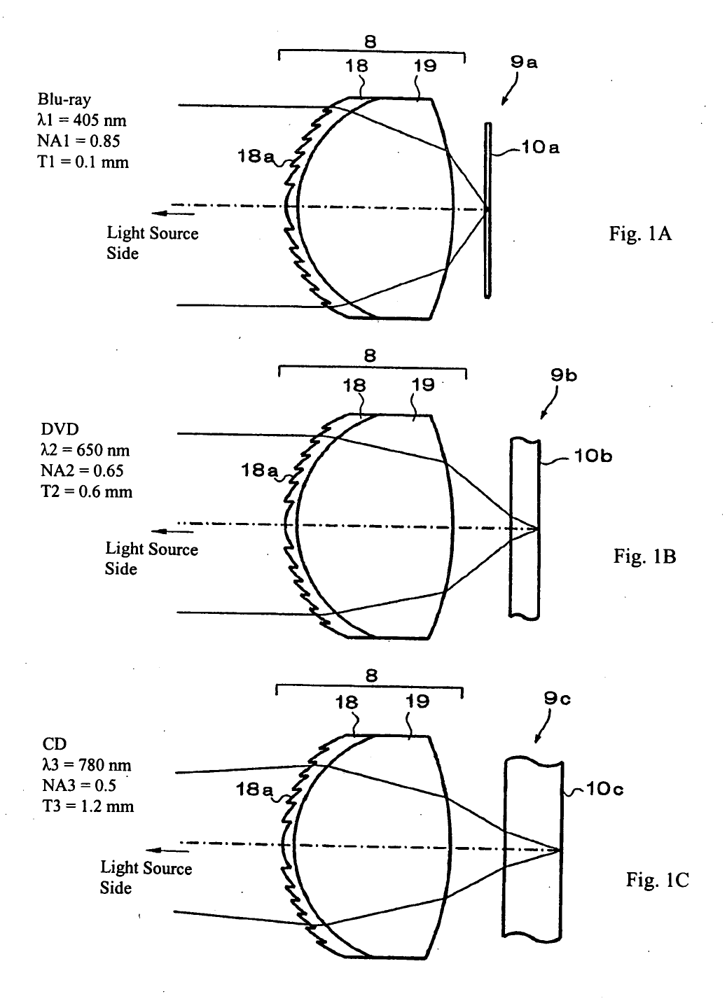

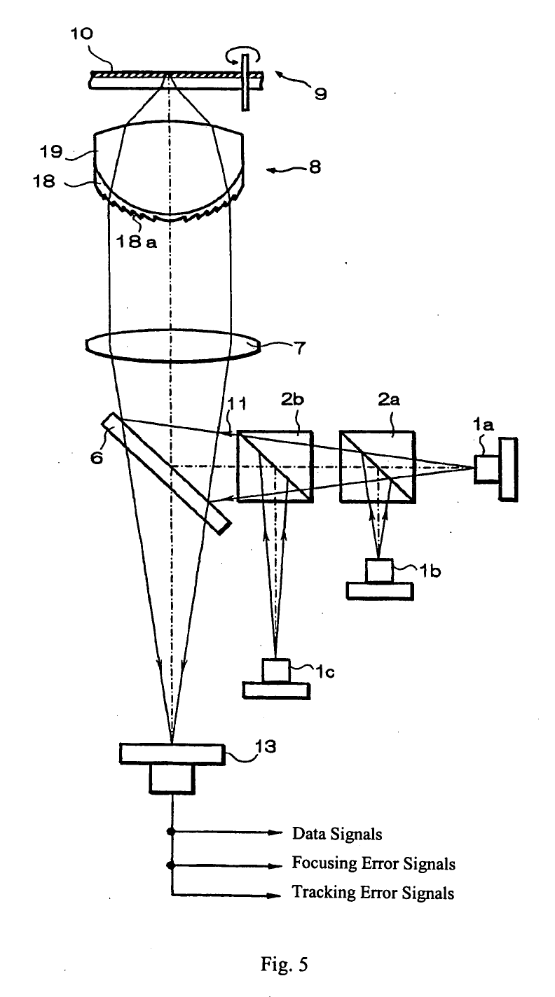

An embodiment of the present invention will be described below with reference to the drawings, specifically with regard to FIGS. 1A-1C and FIG. 5 that illustrate many typical aspects of the present invention. FIGS. 1A-1C are schematic diagrams that depict cross-sectional views of the objective optical system for optical recording media according to Embodiment 1 of the present invention, with FIG. 1A showing the operation of the objective optical system when used with a first optical recording medium 9a, with FIG. 1B showing the operation of the objective optical system when used with a second optical recording medium 9b, and with FIG. 1C showing the operation of the objective optical system when used with a third optical recording medium 9c. FIG. 5 is a schematic diagram of an optical pickup device using the objective optical system according to Embodiment 1. In FIG. 5, in order to avoid complicating the drawing, the edges of the optical beam from the semiconductor laser 1a are fully shown, and the edges of the optical beams from the semiconductor lasers 1b and 1c are shown only until they reach prisms 2a and 2b, respectively.

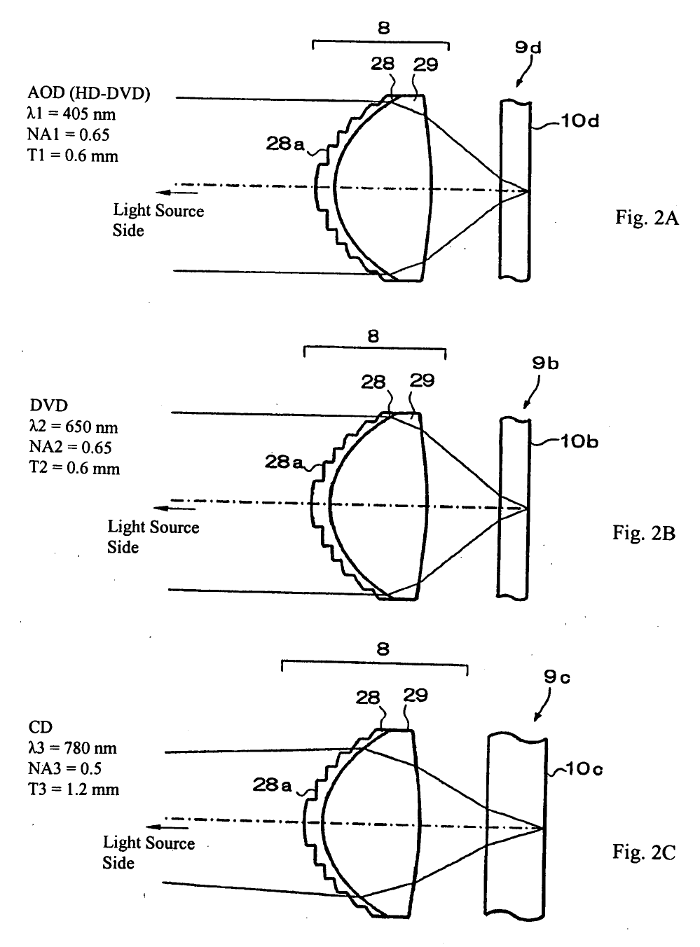

Furthermore, FIGS. 1A-1C (and similarly in FIGS. 2A-2C, 3A-3C, and 4A-4C) and FIG. 5 show the configuration of a first lens element 18 (and similarly lens elements 28, 38, and 48 in FIGS. 2A-2C, 3A-3C, and 4A-4C, respectively) that includes a diffractive surface that is formed on the light source side. The first lens element 18 is joined on its optical recording medium side, that is, the side opposite the light source side, to a second lens element 19 (and similarly lens elements 28, 38, and 48 are joined to lens elements 29, 39, and 49 in FIGS. 2A-2C, 3A-3C, and 4A-4C, respectively) having positive refractive power so that the two lens elements are integrally joined together in order to form a lens component that forms the objective optical system 8 for optical recording media of the present invention. As shown in all the figures, the diffractive surface is on the light source side of the first lens element.

Additionally, as shown in FIGS. 1A-1C, the constitution of the objective optical system is illustrated as simply as possible in terms of lens elements. Definitions of the terms “lens element” and “lens component” that relate to this detailed description will now be given. The term “lens element” is herein defined as a single transparent mass of refractive material having two opposed refracting surfaces, which surfaces are positioned at least generally transversely of the optical axis of the objective optical system. The term “lens component” is herein defined as (a) a single lens element spaced so far from any adjacent lens element that the spacing cannot be neglected in computing the optical image forming properties of the lens elements or (b) two or more lens elements that have their adjacent lens surfaces either in full overall contact or overall so close together that the spacings between adjacent lens surfaces of the different lens elements are so small that the spacings can be neglected in computing the optical image forming properties of the two or more lens elements.

Referring to FIG. 5, in the optical pickup device the laser beam 11 that is output from the semiconductor lasers 1a-1c is reflected by a half mirror 6, and may be made into a collimated light beam by the collimator lens 7. Hereinafter, the term “collimated” means that any divergence or convergence of the light beam is so small that it can be neglected in computing the optical image forming properties of the objective optical system 8 for the light beam. The laser beam 11 is then converted to a convergent beam by the objective optical system 8 so that it is focused onto the recording region 10 of the optical recording medium 9. Rather than all of the light beams being collimated, one or more of the laser beams 11 may be slightly divergent when it exits the collimator lens 7.

The objective optical system is constructed so that light of each wavelength, λ1, λ2, and λ3, diffracted by the diffractive surface is efficiently focused onto the desired position of the corresponding optical recording media of substrate thicknesses, T1, T2, and T3, respectively. In order for this to occur at all three wavelengths, it is preferable that the diffraction order of the diffracted light of at least one wavelength be different from the diffraction order of the diffracted light of at least one other wavelength.

Additionally, the three wavelengths, the diffraction orders of light used, the numerical apertures NA1, NA2, and NA3 of the objective optical system associated with the wavelengths λ1, λ2, and λ3, respectively, and the substrate thickness T1, T2, and T3, respectively, of the three recording media are selected so that the numerical aperture of the objective optical system is never larger for light of a longer wavelength being used and so that the substrate thickness is never smaller for light of a longer wavelength being used.

In summary, throughout the following descriptions the following definitions apply:
NA1 is the numerical aperture of the objective optical system for light of the first wavelength λ1 that is focused on the optical recording medium of substrate thickness T1;
NA2 is the numerical aperture of the objective optical system for light of the second wavelength λ2 that is focused on the optical recording medium of substrate thickness T2; and
NA3 is the numerical aperture of the objective optical system for light of the third wavelength λ3 that is focused on the optical recording medium of substrate thickness T3.

Additionally, in the objective optical system for optical recording media of the present invention, the following conditions are satisfied:
λ1<λ2<λ3 Condition (1)
NA1≧NA2>NA3 Condition (2)
T1≦T2<T3 Condition (3).

The optical recording media 9 collectively refers to optical recording medium 9a that is a BD with a substrate thickness T1 of 0.1 mm used with a light beam of wavelength λ1 that is equal to 405 nm and with a numerical aperture NA1 of 0.85 (FIG. 1A), an optical recording medium 9b that is a DVD with a substrate thickness T2 of 0.6 mm used with a light beam of wavelength λ2 that is equal to 650 nm and with a numerical aperture NA2 of 0.65 (FIG. 1B), and an optical recording medium 9c that is a CD with a substrate thickness T3 of 1.2 mm used with a light beam of wavelength λ3 that is equal to 780 nm and with a numerical aperture NA3 of 0.50 (FIG. 1C). Alternately, the objective optical system may be designed to work with an advanced optical disk (AOD) as the optical recording medium 9d instead of a BD, along with a DVD 9b as the optical recording medium and a CD 9c as the optical recording medium. Additionally, the optical pickup device of the present invention is characterized by being equipped with any of the objective optical systems described herein.

The semiconductor laser 1a emits the visible laser beam having the wavelength of approximately 405 nm (λ1) for BDs. The semiconductor laser 1b emits the visible laser beam having the wavelength of approximately 650 nm (λ2) for DVDs. The semiconductor laser 1c emits the near-infrared laser beam having the wavelength of approximately 780 nm (λ3) for CDs such as CD-R (recordable optical recording media) (hereinafter the term CD generally represents CDs of all types).

The arrangement of FIG. 5 does not preclude semiconductor lasers 1a-1c providing simultaneous outputs. However, it is preferable that the lasers be used alternately depending on whether the optical recording media 9 of FIG. 5 used is specifically, as shown in FIGS. 1A-1C, a BD 9a, a DVD 9b, or a CD 9c. As shown in FIG. 5, the laser beam output from the semiconductor lasers 1a, 1b irradiates the half mirror 6 by way of prisms 2a, 2b, and the laser beam output from the semiconductor laser 1c irradiates the half mirror 6 by way of the prism 2b.

The collimator lens 7 is schematically shown in FIG. 5 as a single lens element. However, it may be desirable to use a collimator lens made up of more than one lens element in order to better correct chromatic aberration of the collimator lens 7 for all of the different wavelengths.

Furthermore, although not shown in the figures, an aperture control element to limit the diameter of incident light beams for setting the numerical aperture (NA) of the optical system at a value corresponding to each optical recording medium can be arranged on the light source side of the objective optical system 8 for optical recording media. The aperture control element can vary the NA, for example, to set the NA at 0.85 for 405 nm wavelength light to be used for a BD, to set the NA at 0.65 for 650 nm wavelength light to be used for a DVD, and to set the NA at 0.5 for 780 nm wavelength light to be used for a CD.

Additionally, as shown in FIGS. 1A-1C, the objective optical system 8 for optical recording media is an objective lens made as a single lens component, wherein the first lens element 18 includes a diffractive surface 18a formed on its light source side and that is joined on its optical recording media side to a second lens element 19 having positive refractive power so as to form an integrated structure in order for each light beam to be focused onto a predetermined position 10a, 10b or 10c (collectively referred to as recording region 10 in FIG. 5) for recording information on or reproducing information from BD 9a as shown in FIG. 1A, DVD 9b as shown in FIG. 1B or CD 9c as shown in FIG. 1C based on the diffractive and refractive effects of the first lens element 18 and the second lens element 19, respectively. This is done while satisfying Conditions (1)-(3) above and provides a simple construction of the optical system that allows for easy assembly, separation adjustment, and alignment adjustment of the various elements of the optical system in order to meet the demands for an inexpensive and compact optical system.

In the recording region 10, pits carrying signal information are arranged in tracks. The reflected light of a laser beam 11 is made incident onto the half mirror 6 by way of the objective optical system 8 and the collimator lens 7 while carrying the signal information, and the reflected light is transmitted through the half mirror 6. The transmitted light is then incident on a four-part photodiode 13. The respective quantities of light received at each of the four parts of the four-part photodiode 13 are converted to electrical signals that are operated on by calculating circuits (not shown in the drawings) in order to obtain data signals and respective error signals for focusing and tracking.

Because the half mirror 6 is inserted into the optical path of the return light from the optical recording media 9 at a forty-five degree angle to the optical axis, the half mirror 6 introduces astigmatism into the light beam, as a cylindrical lens may introduce astigmatism, whereby the amount of focusing error may be determined according to the form of the beam spot of the return light on the four-part photodiode 13. Also, a grating or gratings may be inserted between the semiconductor lasers 1a-1c and the half mirror 6 so that tracking errors can be detected using three beams.

In the objective optical system 8 for optical recording media, it is preferable that the first lens element 18 be formed of plastic and the second lens element 19 be formed of glass. For example, the first lens element 18 can be formed from a resin cured with ultraviolet light. A manufacturing technique for the first lens element 18 includes the following steps:

(1) placing softened ultraviolet curable resin on the light source side surface of the glass second lens element 19;

(2) using a metal mold having a diffractive optical element (DOE) structure, impressing a diffractive structure on the light source side surface of the curable resin, and

(3) irradiating the curable resin with ultraviolet light so that it becomes attached to the light source side of the second lens element 19 with a diffractive surface 18a on the light source side in order to form an integrated structure that defines a lens component that is also a diffractive optical element (DOE). As described above, the configuration wherein the first lens element 18 formed of ultraviolet cured resin is attached to the second lens element 19 enables obtaining a simple integrated structure at low cost.

Furthermore, it is preferable that the cross-sectional configuration of the diffractive structure of the diffractive surface 18a of the objective optical system be serrated. The ‘serrated’ configuration is serrated so as to define a so-called kinoform. FIGS. 1A-1C and FIG. 5 exaggerate the actual size of the serrations of the diffractive surface.

The diffractive surface adds a difference in optical path length equal to m·λ·Φ/(2π) to the diffracted light, where λ is the wavelength, Φ is the phase function of the diffractive surface, and m is the order of the diffracted light that is focused on a recording medium 9. The phase function Φ is given by the following equation:
Φ=ΣBᵢ·Y²ⁱ Equation (A)
where

Y is the distance in mm from the optical axis; and

Bᵢ is a phase function coefficient, and the summation extends over i.

The specific heights of the serrated steps of the diffractive surface 18a of the lens element 18 are based on ratios of diffracted light of each order for the light beams of different wavelengths λ1, λ2, and λ3.

It is preferable that the diffractive surface have a shape so that it diffracts light of the first wavelength λ1 with maximum intensity in a second-order diffracted beam, diffracts light of the second wavelength λ2 with maximum intensity in a first-order diffracted beam, and diffracts light of the third wavelength λ3 with maximum intensity in a first-order diffracted beam. By selecting the diffraction orders in this manner, the diffraction grooves of the diffractive surface can be made shallow, and all three light beams can be converged with high diffraction efficiency without applying an excessive burden on metal mold processing and/or the shaping of the diffractive surfaces.

For example, in the objective optical system 8 for optical recording media according to Embodiments 1 to 4 described later, the diffractive surfaces 18a, 28a, 38a, and 48a are constructed in a manner so as to maximize the quantity of second-order diffracted light for a light beam of wavelength 405 nm (λ1) corresponding to the BD 9a or the AOD 9d, so as to maximize the quantity of first-order diffracted light for a light beam of wavelength 650 nm (λ2) corresponding to the DVD 9b, and so as to maximize the quantity of first-order diffracted light for a light beam of 780 nm (λ3) corresponding to the CD 9c.

All the diffractive surfaces 18a, 28a, 38a, and 48a in the objective optical systems according to Embodiments 1 to 4 are depicted in an exaggerated form in FIGS. 1A to 4C and FIG. 5 as compared to the actual forms of the diffractive surfaces.

Furthermore, in the objective optical system 8 for optical recording media of the present invention, it is preferable that at least one surface of the second lens element 19 be an aspheric surface. This aspheric surface can be the surface of the second lens element 19 on the light source side that is joined to a surface of the first lens element 18. It is preferable that the surface configuration of this aspheric surface be appropriately established so as to contribute to appropriate convergence of the light beams so as to achieve focused light with well corrected aberrations on the corresponding recording region 10.

Additionally, it is preferable that the aspheric surface(s) be rotationally symmetric aspheric surfaces defined using the following aspheric equation in order to improve aberration correction for all of the light beams focused on the various recording media 9 during recording and reproducing information.:
Z=[(C·Y²)/{1+(1−K·C²·Y²)^{1/2}}]+ΣAᵢ·Y²i Equation (B)
where
Z is the length (in mm) of a line drawn from a point on the aspheric lens surface at a distance Y from the optical axis to the tangential plane of the aspheric surface vertex,
C is the curvature (=1/the radius of curvature, R in mm) of the aspheric lens surface on the optical axis,
Y is the distance (in mm) from the optical axis,
K is the eccentricity, and
Aᵢ is an aspheric coefficient, and the summation extends over i.

Making the lens element 19 of FIG. 5 of glass is advantageous because glass is little affected by normal changes in temperature and humidity, and appropriate glass types are readily available for which a decrease in the light transmittance with prolonged use is small, even at relatively short wavelengths used for a long time.

Making the lens element 18 of plastic is advantageous in reducing manufacturing costs, making manufacturing easier, and in making the system lighter, which may assist in high speed recording and replaying. Also, using plastic enables ease of manufacture using a metal mold.

The objective optical system for optical recording media of the present invention is more specifically described hereafter, with reference to Embodiments 1 to 4. Furthermore, the first lens elements 28, 38 and 48, the diffractive surfaces 28a, 38a and 48a, and the second lens elements 29, 39 and 49 in the objective optical systems for optical recording media relating to Embodiments 2 to 4, respectively, function in about the same manner as the corresponding parts of Embodiment 1, specifically, the first lens element 18, the diffractive surface 18a, and the second lens element 19 (having positive refractive power), respectively. Therefore, any redundant description is omitted.

### EMBODIMENT 1

FIGS. 1A-1C are schematic diagrams that depict cross-sectional views of the objective optical system 8 for optical recording media of Embodiment 1 of the present invention, with FIG. 1A showing the operation of the objective optical system when used with a first optical recording medium 9a, with FIG. 1B showing the operation of the objective optical system when used with a second optical recording medium 9b, and with FIG. 1C showing the operation of the objective optical system when used with a third optical recording medium 9c. As shown in FIGS. 1A-1C, the objective optical system 8 for optical recording media of Embodiment 1 of the present invention is an objective lens that includes, in order from the light source side, the first lens element 18 with the diffractive surface 18a on the light source side, and the second lens element 19 having positive refractive power. The two lens elements 18 and 19 are integrally joined together to form a lens component. The second lens element 19 is a biconvex lens element with both surfaces being rotationally symmetrical aspheric surfaces.

In the objective optical system 8 for optical recording media, as shown in FIGS. 1A-1C, while the numerical aperture (NA) is controlled at a predetermined value (numerical aperture NA1=0.85 for the BD 9a, numerical aperture NA2=0.65 for the DVD 9b and numerical aperture NA3=0.50 for the CD 9c) for light beams with wavelengths λ=405 nm (λ1), λ=650 nm (λ2) and λ=780 nm (λ3), which are the light beams to be used, respectively, the light beams are excellently focused onto the recording region 10a, 10b or 10c for the BD 9a, the DVD 9b or the CD 9c, respectively.

In the objective optical system 8 for optical recording media of Embodiment 1, when the BD 9a or DVD 9b is selected as the optical recording medium 9, light enters into the objective optical system 8 as collimated light. When the CD 9c is selected as the optical recording medium 9, light enters into the objective optical system 8 as diverging light.

In Embodiment 1, as well as in Embodiments 2-4 described below, it is common for the diffractive surface to be defined by the phase function of Equation (A) above and the rotationally symmetric aspheric surface(s) to be defined by Equation (B) above. It is also common in Embodiments 1 to 4 that the cross-sectional configuration of the diffractive surface be formed as serrated concentric gratings. It is also common in Embodiments 1 to 4 that each light beam be alternately transmitted according to the optical recording medium 9 being used.

### EMBODIMENT 2

The objective optical system 8 for optical recording media of Embodiment 2 uses an AOD 9d with a numerical aperture NA1=0.65, light of wavelength λ1=405 nm, and substrate thickness T1=0.6 mm, instead of a BD 9a as in Embodiment 1. As shown in FIGS. 2A-2C, the objective optical system 8 for optical recording media is an objective lens that includes, in order from the light source side, the first lens element 28 with the diffractive surface 28a on the light source side, and the second lens element 29 having positive refractive power. The two lens elements 28 and 29 are integrally joined together to form a lens component. The second lens element 29 is a biconvex lens element with both surfaces being rotationally symmetrical aspheric surfaces.

In the objective optical system 8 for optical recording media, as shown in FIGS. 2A-2C, while the numerical aperture (NA) is controlled at a predetermined value (numerical aperture NA1=NA2=0.65 for the AOD 9d and DVD 9b, and numerical aperture NA3=0.50 for the CD 9c) for light beams with wavelengths λ=405 nm (λ1), λ=650 nm (λ2) and λ=780 nm (λ3), which are the light beams to be used, respectively, the light beams are excellently focused onto the recording region 10d, 10b or 10c for the AOD 9d, the DVD 9b or the CD 9c, respectively.

In the objective optical system 8 for optical recording media of Embodiment 2, when the AOD 9d or the DVD 9b is selected as the optical recording medium 9, light enters into the objective optical system 8 as collimated light. When the CD 9c is selected as the optical recording medium 9, light enters into the objective optical system 8 as diverging light.

### EMBODIMENT 3

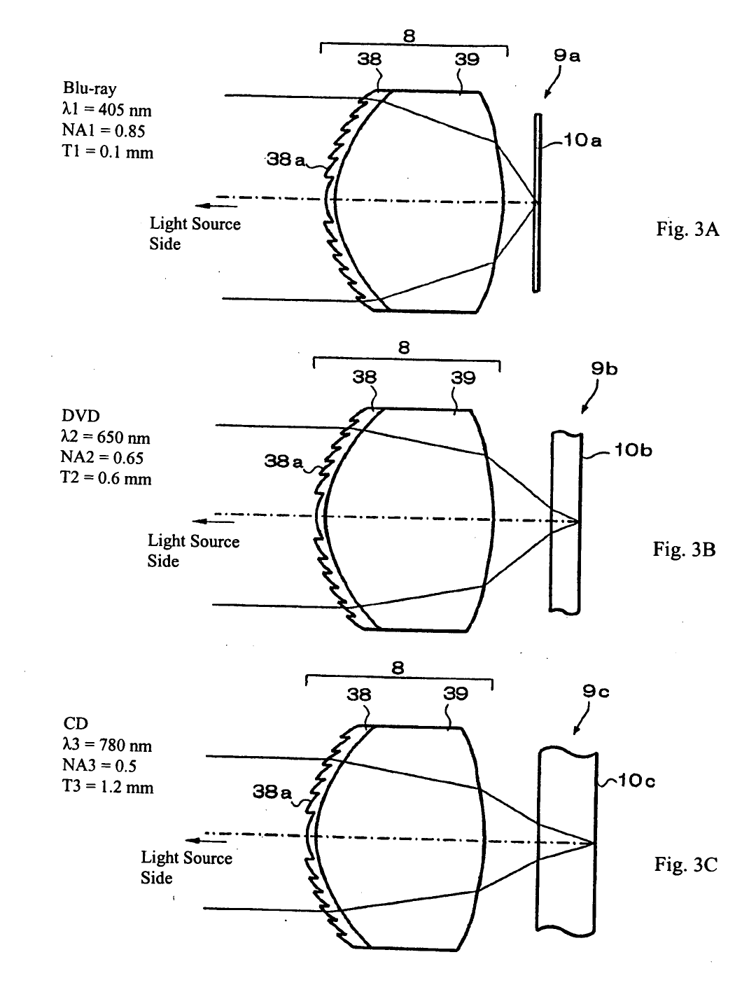

As shown in FIGS. 3A-3C, the objective optical system 8 for optical recording media of Embodiment 3 is an objective lens that includes, in order from the light source side, the first lens element 38 with the diffractive surface 38a on the light source side, and the second lens element 39 having positive refractive power. The two lens elements 38 and 39 are integrally joined together to form a lens component. The second lens element 39 is a biconvex lens element with both surfaces being rotationally symmetrical aspheric surfaces.

In the objective optical system 8 for optical recording media, as shown in FIGS. 3A-3C, while the numerical aperture (NA) is controlled at a predetermined value (numerical aperture NA1=0.85 for the BD 9a, numerical aperture NA2=0.65 for the DVD 9b, and numerical aperture NA3=0.50 for the CD 9c) for light beams with wavelengths λ=405 nm (λ1), λ=650 nm (λ2) and λ=780 nm (λ3), which are the light beams to be used, respectively, the light beams are excellently focused onto the recording region 10a, 10b or 10c for the BD 9a, the DVD 9b or the CD 9c, respectively.

Furthermore, in the objective optical system 8 for optical recording media of Embodiment 3, when any one of the BD 9a, the DVD 9b, or the CD 9c is selected as the optical recording medium 9, the light enters into the objective optical system 8 as collimated light.

### EMBODIMENT 4

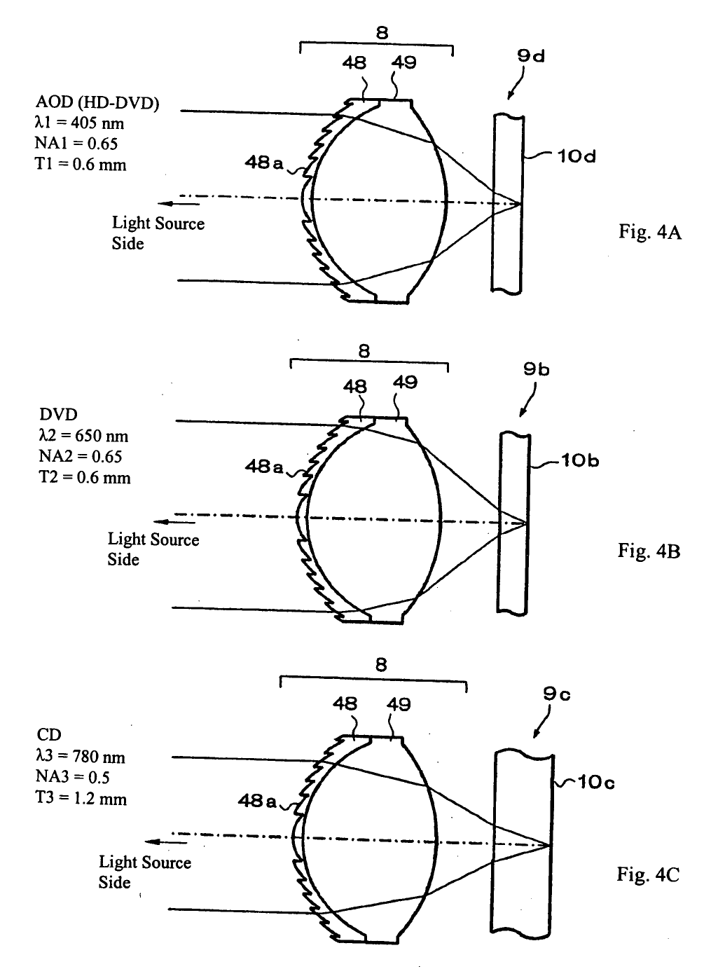

As shown in FIGS. 4A-4C, the objective optical system 8 for optical recording media of Embodiment 4 is an objective lens that includes, in order from the light source side, the first lens element 48, with the diffractive surface 48a on the light source side, and the second lens element 49 having positive refractive power. The two lens elements 48 and 49 are integrally joined together to form a lens component. The second lens element 49 is a biconvex lens element with both surfaces being rotationally symmetrical aspheric surfaces.

In the objective optical system 8 for optical recording media, as shown in FIGS. 4A-4C, while the numerical aperture (NA) is controlled at a predetermined value (numerical aperture NA1=NA2=0.65 for the AOD 9d and the DVD 9b and numerical aperture NA3=0.50 for the CD 9c) for light beams with wavelengths λ=405 nm (λ1), λ=650 nm (λ2) and λ=780 nm (λ3), which are the light beams to be used, respectively, the light beams are excellently focused onto the recording region 10d, 10b or 10c for the AOD 9d, the DVD 9b or the CD 9c, respectively. Furthermore, in the objective optical system 8 for optical recording media of Embodiment 4, when any one of the AOD 9d, the DVD 9b, or the CD 9c is selected as the optical recording medium 9, the light enters into the objective optical system 8 as collimated light.

The objective optical system for optical recording media of the present invention is not limited to the embodiments described above, but rather may be modified in various ways. Similarly, the optical pickup device of the present invention can be modified in various ways. For example, regarding the diffractive surface, as long as it is constructed so that a large amount of light of the appropriate wavelength is diffracted into the predetermined order of diffraction relative to light of other wavelengths, it is acceptable. Ideally, if substantially one hundred percent of the incident light is diffracted, the highest efficiency is obtained. Furthermore, the shape of the diffractive structure is not limited to a serrated configuration; for example, a stair step configuration may also be used.

Furthermore, the second lens element is not limited to a biconvex shape as described in the embodiments above, but other shapes providing positive refractive power to the second lens element are acceptable. Additionally, the construction is not limited to having rotationally symmetric surfaces on both sides. For example, a flat surface, a spherical surface, or a rotationally asymmetric aspheric surface may be appropriately used.

Additionally, in the objective optical system for optical recording media and the optical pickup device of the present invention, the optical recording media which are the subject for recording and reproducing information are not limited to the combination of a BD (or an AOD), a DVD, and a CD. The present invention can be appropriately applied when recording information on or reproducing information from any optical recording media established so as to satisfy the Conditions (1)-(3) above.

Furthermore, instead of arranging an aperture control element to limit the diameter of an incident light beam in order to establish the numerical aperture of the optical system at a value appropriate to each optical recording medium, the objective optical system 8 can have a function to limit the aperture without the use of a separate aperture control element.

Additionally, in the case of having a BD (or an AOD), a DVD and a CD as the optical recording media as described in the embodiments above, the wavelengths of the light beams to be used are not limited to those described in the embodiments above. Even if the wavelengths of the light beams to be used for a BD and AOD, for a DVD and for a CD are other than 405 nm, 650 nm and 780 nm, respectively, as long as the wavelengths satisfy the standards of each optical recording medium, the wavelengths can be varied within a range that satisfies the standards. Similar considerations apply to setting numerical apertures and the substrate thicknesses.

Furthermore, it is assumed that an optical recording medium other than those described above will be developed in the future, and for example, such a new optical recording medium may be standardized to use a wavelength that is shorter than those of the embodiments described above. Needless to say, the present invention is applicable even in such a case. In such a case, it is preferable to use a material for the lens material that has an excellent transmissivity for the wavelength of light to be used. For example, it is possible to use fluorite or quartz in lieu of optical glass for a lens element of the objective optical system for optical recording media of the present invention.

Also, objective optical systems and optical pickup devices using four or more types of optical recording media may be used in various applications of the objective optical system for optical recording media of the present invention.

Furthermore, three light sources are used in the objective optical systems and optical pickup devices of the embodiments described above. However, they can be designed to use one light source that can transmit two light beams with different wavelengths from adjacent output ports. In this case, for example, instead of the prisms 2a and 2b shown in FIG. 5, a single prism may be used. In addition, they can be designed to use one light source that can transmit three light beams of different wavelengths from adjacent output ports. In this case, for example, the prisms 2a and 2b shown in FIG. 5 become unnecessary.

Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An objective optical system for focusing light from a light source onto optical recording media comprising an objective lens that includes, arranged in order from the light source side along an optical axis:
a first lens element having a diffractive surface on its light source side; and
a second lens element having positive refractive power;
wherein
said first lens element and said second lens element are joined to form a lens component; and
the objective optical system is configured to receive a light beam of a first wavelength λ1 from its light source side and focus diffracted light diffracted by said diffractive surface at a first numerical aperture NA1 onto a desired portion of a first optical recording medium having a substrate thickness T1, to receive a light beam of a second wavelength λ2 from its light source side and focus diffracted light diffracted by said diffractive surface at a second numerical aperture NA2 onto a desired portion of a second optical recording medium having a substrate thickness T2, and to receive a light beam of a third wavelength λ3 from its light source side and focus diffracted light diffracted by said diffractive surface at a third numerical aperture NA3 onto a desired portion of a third optical recording medium having a substrate thickness T3; and
the following conditions are satisfied:
λ1<λ2<λ3
NA1≧NA2>NA3
T1≦T2<T3.

2. The objective optical system according to claim 1, wherein said first lens element is made of plastic and said second lens element is made of glass.

3. The objective optical system according to claim 1, wherein at least one surface of said second lens element is an aspheric surface.

4. The objective optical system according to claim 2, wherein at least one surface of said second lens element is an aspheric surface.

5. The objective optical system according to claim 1, wherein said first optical recording medium is an AOD, said second optical recording medium is a DVD, and said third optical recording medium is a CD.

6. The objective optical system according to claim 2, wherein said first optical recording medium is an AOD, said second optical recording medium is a DVD, and said third optical recording medium is a CD.

7. The objective optical system according to claim 3, wherein said first optical recording medium is an AOD, said second optical recording medium is a DVD, and said third optical recording medium is a CD.

8. The objective optical system according to claim 4, wherein said first optical recording medium is an AOD, said second optical recording medium is a DVD, and said third optical recording medium is a CD.

9. The objective optical system according to claim 1, wherein said first optical recording medium is a Blu-ray disk, said second optical recording medium is a DVD, and said third optical recording medium is a CD.

10. The objective optical system according to claim 2, wherein said first optical recording medium is a Blu-ray disk, said second optical recording medium is a DVD, and said third optical recording medium is a CD.

11. The objective optical system according to claim 3, wherein said first optical recording medium is a Blu-ray disk, said second optical recording medium is a DVD, and said third optical recording medium is a CD.

12. The objective optical system according to claim 4, wherein said first optical recording medium is a Blu-ray disk, said second optical recording medium is a DVD, and said third optical recording medium is a CD.

13. An optical pickup device that includes the objective optical system of claim 1.

14. An optical pickup device that includes the objective optical system of claim 2.

15. An optical pickup device that includes the objective optical system of claim 3.

16. An optical pickup device that includes the objective optical system of claim 4.

17. An optical pickup device that includes the objective optical system of claim 5.

18. An optical pickup device that includes the objective optical system of claim 6.

19. An optical pickup device that includes the objective optical system of claim 9.

20. An optical pickup device that includes the objective optical system of claim 10.
